(19) United States
(12) Patent Application Publication
(10) Pub. No.: US 2025/0061553 A1
(43) Pub. Date: Feb. 20, 2025

(54) ELECTRONIC DEVICES, SYSTEMS AND METHODS FOR CONVERTING AN INPUT IMAGE INTO AN OUTPUT IMAGE

(71) Applicant: FONDATION B-COM, Cesson-sevigne (FR)

(72) Inventors: Olivier WEPPE, Cesson-sevigne (FR); Benoît LE LUDEC, Cesson-sevigne (FR); Foteini Tania POULI, Le Rheu (FR)

(21) Appl. No.: 18/720,185

(22) PCT Filed: Dec. 15, 2021
(86) PCT No.: PCT/IB2021/000880

§ 371 Date: Jun. 14, 2024

(51) Int. Cl. G06T 5/90; G06T 3/40

(52) U.S. Cl. CPC G06T 5/90; G06T 3/40

(57) ABSTRACT

An electronic device for converting an input image having a first dynamic range into an output image having a second dynamic range comprises a computing unit and a converting unit, wherein: —the computing unit comprises a computing input physical interface and a computing output physical interface, —the converting unit comprises a converting input physical interface, a parameter input physical interface and a converting output physical interface, —the computing unit is configured to receive data representative of a first image via the computing input physical interface, —the converting unit is configured to receive data representative of a second image via the converting input physical interface, —the computing unit is configured to compute at least one statistical parameter characteristic of the first image, —the computing unit is configured to transmit the at least one statistical parameter characteristic of the first image via the computing output physical interface, —the converting unit is configured to receive entry data via the parameter input physical interface, —the converting unit is configured to convert the second image into at least one part of the output image based on the entry data.

### TECHNICAL FIELD OF THE INVENTION

The invention relates to the field of image processing.

More particularly, the invention relates to electronic devices, systems and methods for converting an input image into an output image.

### BACKGROUND INFORMATION

Image processing devices have been proposed for converting an input image having a first dynamic range (for instance a “Standard Dynamic Range” or SDR) into an output image having a second dynamic range (for instance a “High Dynamic Range” or HDR) that is higher than the first dynamic range. Such a conversion is generally called “tone expansion”. The reverse conversion may also be used, known as “tone compression”.

Such an image processing device may be implemented in a monolithic architecture, for instance using the Field Programmable Gate-Array (FPGA) technology. This technology is interesting as it has a limited energy consumption and a small size facilitating its integration in larger systems.

### SUMMARY OF THE INVENTION

In this context, the invention provides an electronic device for converting an input image having a first dynamic range into an output image having a second dynamic range different from the first dynamic range, the electronic device comprising a computing unit and a converting unit, wherein:
the computing unit comprises a computing input physical interface and a computing output physical interface,
the converting unit comprises a converting input physical interface, a parameter input physical interface and a converting output physical interface,
the computing unit is configured to receive data representative of a first image via the computing input physical interface,
the converting unit is configured to receive data representative of a second image via the converting input physical interface,
the computing unit is configured to compute at least one statistical parameter characteristic of the first image,
the computing unit is configured to transmit the at least one statistical parameter characteristic of the first image via the computing output physical interface,
the converting unit is configured to receive entry data via the parameter input physical interface,
the converting unit is configured to convert the second image into at least one part of the output image based on the entry data.

Such an electronic device presents a split architecture comprising two independent units, the computing unit and the converting unit. This allows for higher flexibility in designing image processing devices and for better implementation of complex workflows.

In an embodiment, the electronic device further comprises a buffer, wherein:
the buffer comprises a buffer input physical interface and a buffer output physical interface,
the buffer is configured to receive the data representative of the first image via the buffer input physical interface and to store the data representative of the first image while the computing unit computes the at least one statistical parameter characteristic of the first image,
the buffer is configured to transmit the data representative of the first image via the buffer output physical interface to the converting unit via the converting input physical interface once the computing unit has computed the at least one statistical parameter characteristic of the first image.

For instance, the entry data comprise the at least one statistical parameter characteristic of the first image.

For instance, the electronic device further comprises a memory, wherein:
the memory comprises a memory input physical interface and a memory output physical interface,
the memory is configured to receive the at least one statistical parameter characteristic of the first image from the first output physical interface via the memory input physical interface,
the first image corresponds to an image inferred from another image.

In an embodiment, the first image and the second image are two successive images of a sequence of images and the entry data are based on the at least one statistical parameter characteristic of the first image.

For instance, the entry data comprise the at least one statistical parameter characteristic of the first image.

For instance, the electronic device further comprises a memory, wherein:
the memory comprises a memory input physical interface and a memory output physical interface,
the memory is configured to receive, once the computing unit has computed the at least one statistical parameter characteristic of the first image, said at least one statistical parameter characteristic of the first image, and to transmit said at least one statistical parameter characteristic of the first image via the memory output physical interface,
the second image correspond to a second sub-image of the input image.

In some embodiments, the electronic device further comprises at least one parameter memory configured to store properties of the input image.

In an embodiment, the electronic device further comprises an upscaling unit, wherein:
the upscaling unit comprises an upscaling input physical interface and an upscaling output physical interface,
the first image corresponds to a low resolution image,
the upscaling unit is configured to receive data representative of the low resolution image via the upscaling input physical interface, to upscale the low resolution image into a high resolution image and to transmit data representative of the high resolution image via the upscaling output physical interface to the converting unit via the converting input physical interface.

One other aspect of the invention pertains to an electronic system comprising a first electronic device according to the invention and a second electronic device according to the invention, further comprising a weighting unit, wherein the weighting unit comprises a weighting input physical interface and a weighting output physical interface.

In a first case, the memory of the first electronic device and the memory of the second electronic device are configured to transmit the at least one statistical parameters respectively characteristic of the first sub-image received by the computing unit of the first electronic device and of the first sub-image received by the computing unit of the second electronic device to the weighting unit via the memory output physical interface of the first electronic device and the memory output physical interface of the second electronic device,

In this case, the weighting unit is configured to compute a weighted average of the at least one statistical parameters respectively characteristic of the first image received by the computing unit of the first electronic device and of the first image received by the computing unit of the second electronic device. In this case, the entry data received by the first electronic device and the entry data received by the second electronic device comprise said weighted average.

In a second case, the memory of the first electronic device and the memory of the second electronic device are configured to transmit the at least one statistical parameters respectively characteristic of the first image received by the computing unit of the first electronic device and of the first image received by the computing unit of the second electronic device to the weighting unit via the memory output physical interface of the first electronic device and the memory output physical interface of the second electronic device.

In this case, the weighting unit is configured to compute a weighted average of the at least one statistical parameters respectively characteristic of the first image received by the computing unit of the first electronic device and of the first image received by the computing unit of the second electronic device. In this case, the second image received by the converting unit of the first electronic device and the second image received by the converting unit of the second electronic device are sub-images of the input image. In this case, the entry data received by the first electronic device and the entry data received by the second electronic device comprise said weighted average.

One other aspect of the invention pertains to a method for converting an input image having a first dynamic range into an output image having a second dynamic range different from the first dynamic range, comprising the steps of:
receiving, by a computing unit via a computing input physical interface of the computing unit, data representative of a first image,
computing, by the computing unit, at least one statistical parameter characteristic of the first image,
receiving, by a converting unit via a computing input physical interface of the converting unit, data representative of a second image,
receiving, by the converting unit via a parameter input physical interface of the converting unit, entry data,
converting, by the converting unit, the second image into at least one part of the output image, based on the entry data.

For instance, the data representative of the first image are received by a buffer via a buffer input physical interface of the buffer and stored by the buffer while the computing unit computes the at least one statistical parameter characteristic of the first image, and the data representative of the first image are received by the converting unit, via the converting input physical interface, from the buffer via a buffer output physical interface of the buffer once the computing unit has computed the at 10 least one statistical parameter characteristic of the first image.

For instance, the entry data comprise the at least one statistical parameter characteristic of the first image.

For instance, the at least one statistical parameter characteristic of the first image is received from the computing unit via a computing output physical interface by a memory via a memory input physical interface, and the first image corresponds to a first sub-image of the input image.

In an embodiment, the first image and the second image are two successive images of a sequence of images, and the entry data are based on the at least one statistical parameter characteristic of the first image.

For instance, the entry data comprise the at least one statistical parameter characteristic of the first image.

For instance, once the computing unit has computed the at least one statistical parameter characteristic of the first image, the at least one statistical parameter characteristic of the first image is received by a memory via a memory input physical interface, then transmitted via the memory output physical interface. In this case, the second image correspond to a second sub-image of the input image.

In an embodiment:
the first image corresponds to a low resolution image,
data representative of the low resolution image are received by an upscaling unit via an upscaling input physical interface,
the low resolution image is upscaled by the upscaling unit into a high resolution image,
data representative of the high resolution image are transmitted by the upscaling unit via an upscaling output physical interface to the converting unit via the converting input physical interface.

One other aspect of the invention pertains to a method for converting an input image having a first dynamic range into an output image having a second dynamic range different from the first dynamic range, comprising the steps of:
receiving, by a first computing unit and a second computing unit via respectively a first computing input physical interface of first computing unit and a second computing input physical interface of the second computing unit, first sub-images of the input image,
computing, respectively by the first computing unit and the second computing unit, a first at least one statistical parameter and a second at least one statistical parameter,
receiving, by a first converting unit and a second converting unit via respectively a first converting input physical interface of the first converting unit and a second converting input physical interface of the second converting unit, second sub-images of the input image,
receiving, by an weighting unit via an weighting input physical interface, the first at least one statistical parameter and the second at least one statistical parameter,
computing, by the first weighting unit, a weighted average of the first at least one statistical parameter and the second at least one statistical parameter,
receiving and storing, by a first buffer and the second buffer via respectively a first buffer input physical interface of the first buffer and a second buffer input physical interface of the second buffer, data representative of the first sub-images, while the first computing unit and the second computing unit compute the first at least one statistical parameter and the second at least one statistical parameter,
transmitting, by the first buffer and the second buffer, said data representative of the first sub-images, to respectively the first converting unit and the second converting unit, once the first computing unit and the second computing unit have computed the first at least one statistical parameter and the second at least one statistical parameter,
receiving, by the first converting unit and the second converting unit via respectively a first parameter input physical interface and a second parameter input physical interface, entry data, wherein the entry data comprise the weighted average,
converting, by the first converting unit and the second converting unit, the second sub-images into the output image, based on the entry data.

One other aspect of the invention pertains to a method for converting an input image having a first dynamic range into an output image having a second dynamic range different from the first dynamic range, comprising the steps of:
receiving, by a first computing unit and a second computing unit via respectively a first computing input physical interface of first computing unit and a second computing input physical interface of the second computing unit, first sub-images of a preceding image, the preceding image and the input image being two successive images in a sequence of images,
computing, respectively by the first computing unit and the second computing unit, a first at least one statistical parameter and a second at least one statistical parameter,
receiving, by a first converting unit and a second converting unit via respectively a first converting input physical interface of the first converting unit and a second converting input physical interface of the second converting unit, second sub-images of the input image,
receiving, by a first memory and a second memory via respectively a first memory input physical interface and a second memory input physical interface, once the first computing unit and the second computing unit have computed the first at least one statistical parameter and the second least one statistical parameter, said first at least one statistical parameter and said second at least one statistical parameter,
   receiving, from the first memory and the second memory, by a weighting unit via a weighting input physical interface, the first at least one statistical parameter and the second at least one statistical parameter,
computing, by the weighting unit, a weighted average of the first at least one statistical parameter and the second at least one statistical parameter,
receiving, by the first converting unit and the second converting unit via respectively a first parameter input physical interface and a second parameter input physical interface, entry data, wherein the entry data each comprise the weighted average,
converting, by the first converting unit and the second converting unit, the second sub-images into the output image, based on the entry data.

One other aspect of the invention pertains to a method, implemented by an electronic device according to the invention, for converting a first sequence of images and a second sequence of images, comprising the steps of:
applying a current image of the first sequence of images to the computing unit via the computing input physical interface, thereby producing at least one statistical parameter characteristic of said current image of the first sequence of images, while applying a current image of the second sequence of images (and at least one statistical parameter characteristic of said current image of the second sequence of images) to the converting unit via (respectively) the converting input physical interface (and the parameter input physical interface),
applying the image subsequent to said current image of the second sequence of images to the computing unit via the computing input physical interface (thereby producing at least one statistical parameter characteristic of said image subsequent to said current image of the second sequence of images), while applying the current image of the first sequence of images and the at least one statistical parameter characteristic of said current image of the first sequence of images to the converting unit via respectively the converting input physical interface and the parameter input physical interface.

Finally, another aspect of the invention pertains to a method, implemented by an electronic device according to the invention, for converting a first sequence of images and a second sequence of images, comprising the steps of:
applying a current image of the first sequence of images to the computing unit via the computing input physical interface, thereby producing at least one statistical parameter characteristic of said current image of the first sequence of images, while applying a current image of the second sequence of images (and at least one statistical parameter characteristic of an image immediately preceding said current image of the second sequence of images) to the converting unit via (respectively) the converting input physical interface (and the parameter input physical interface),
applying the image subsequent to said current image of the second sequence of images to the computing unit via the computing input physical interface (thereby producing at least one statistical parameter characteristic of said image subsequent to said current image of the second sequence of images), while applying the current image of the first sequence of images and the at least one statistical parameter characteristic of said current image of the first sequence of images to the converting unit via respectively the converting input physical interface and the parameter input physical interface.

### DETAILED DESCRIPTION OF EXAMPLE(S)

The following description with reference to the accompanying drawings will make it clear what the invention consists of and how it can be achieved. The invention is not limited to the embodiment/s illustrated in the drawings. Accordingly, it should be understood that where features mentioned in the claims are followed by reference signs, such signs are included solely for the purpose of enhancing the intelligibility of the claims and are in no way limiting on the scope of the claims.

In the accompanying drawings:

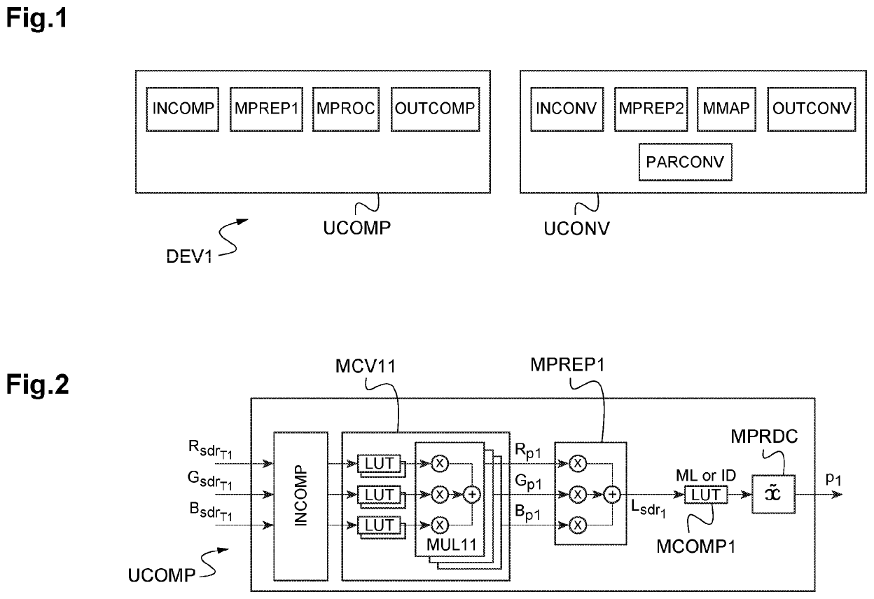

FIG. 1 is a schematic illustration of an electronic device according to the invention.

FIG. 2 illustrates an example of implementation of a computing unit according to the invention.

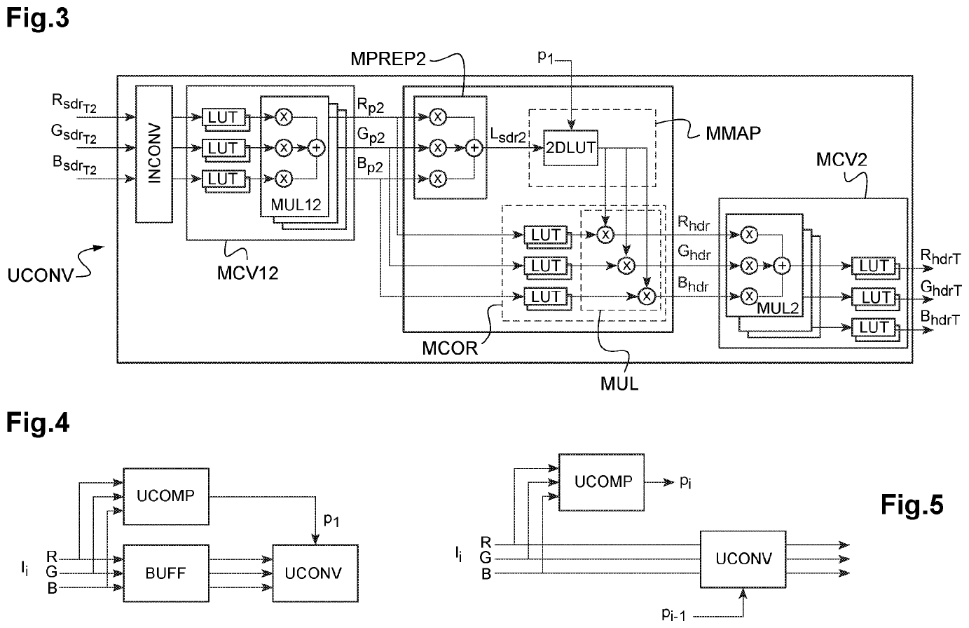

FIG. 3 illustrates an example of implementation of a converting unit according to the invention.

FIG. 4 is a schematic illustration of a first embodiment of the electronic device according to the invention, called “high precision embodiment” hereinafter.

FIG. 5 is a schematic illustration of a second embodiment of the electronic device according to the invention, called “low latency embodiment” hereinafter.

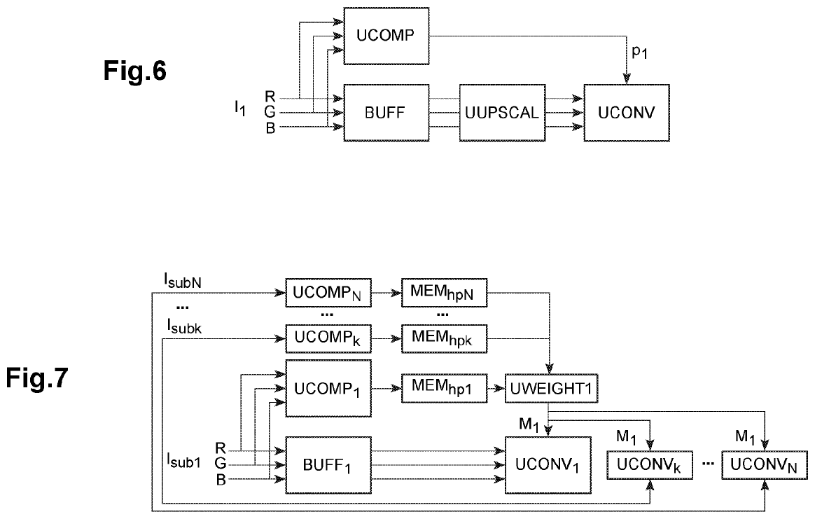

FIG. 6 is a schematic illustration of a third embodiment of the electronic device according to the invention, called “upscaling embodiment” hereinafter.

FIG. 7 is a schematic illustration of an embodiment of an electronic system according to the invention.

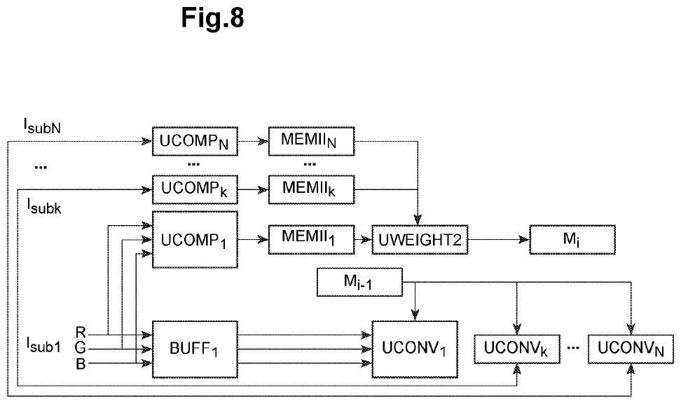

FIG. 8 is a schematic illustration of another embodiment of an electronic system according to the invention.

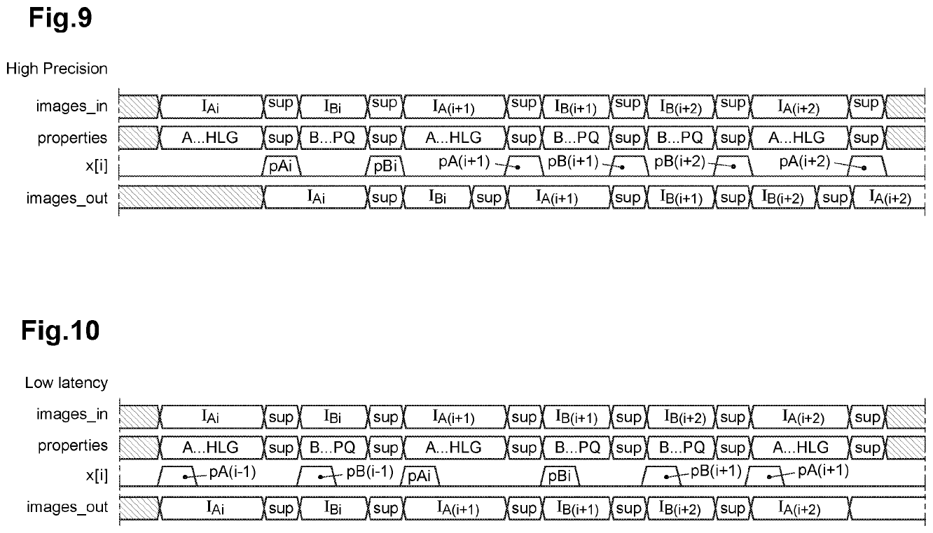

FIG. 9 is a chronogram illustrating an embodiment of a multiplexing method according to the invention.

FIG. 10 is a chronogram illustrating another embodiment of a multiplexing method according to the invention.

The invention aims at improving the performances of an electronic device dedicated to image processing, by separating it into two independent units. The goal of this separation is to allow for combination and chaining of the two independent units, which will be found to provide flexibility and ability to deal with complex workflows.

FIG. 1 illustrates schematically and in a general manner the elements present in an electronic device DEV1 according to the invention.

The electronic device DEV1 is designed to convert an input image I_{sdr} having a first dynamic range Δsdr (for instance a standard dynamic range or SDR) into an output image I_{hdr} having a second dynamic range Δhdr distinct from the first dynamic (for instance a high dynamic range or HDR). The input image I_{sdr} may be a still image or an image belonging to a sequence of images.

For example here, the second dynamic range Δhdr is higher than the first dynamic range Δsdr. Such a process of converting an input image I_{sdr} having a first dynamic range Δsdr into an output image Ihdr having a second dynamic range Δhdr higher than the first dynamic range Δsdr is generally referred to as “tone expansion”.

As an alternative, the electronic device DEV1 can be used to provide the opposite conversion, thus converting an input image having a high dynamic range into an output image a standard dynamic range. Such a process of conversion is generally referred as “tone compression”.

The input image I_{sdr} is represented, using a set of pixels (generally a matrix of pixels) of the input image I_{sdr}, by a plurality of component values Rₚ, Gₚ, Bₚ for each pixel p.

In the present example, the input image I_{sdr} is represented by three colour components Rₚ, Gₚ, Bₚ for each pixel p (namely a red component Rₚ, a green component Gₚ and a blue component Bₚ). Another representation may however be used for the input image I_{sdr}, such as for instance using a luminance component Yₚ and two chro-minance components Uₚ, Vₚ for each pixel p.

The electronic device DEV1 comprises a computing unit UCOMP and a converting unit UCONV.

The computing unit UCOMP comprises a computing input physical interface INCOMP and a computing output physical interface OUTCOMP.

By input physical interface, it is meant at least one physical interconnection, such as a pin or a plurality of pins, presenting an end outgoing from the computing unit and through which data may be received from units external to the computing unit.

By output physical interface, it is meant at least one physical interconnection, such as a pin or a plurality of pins, presenting an end outgoing from the computing unit UCOMP through which data may be sent out to units or devices external to the computing unit UCOMP. An example of implementation of the computing unit UCOMP is described below with reference to FIG. 2.

The converting unit UCONV comprises a converting input physical interface INCONV, a parameter input physical interface PARCONV and a converting output physical interface OUTCONV. By input physical interface, it is meant at least one physical interconnection, such as a pin or a plurality of pins, presenting an end outgoing from the converting unit UCONV and through which data may be received from units external to the converting unit. An example of implementation of the converting unit UCONV is described below with reference to FIG. 3.

By parameter input physical interface, it is meant at least one physical interconnection, such as a pin or a plurality of pins, presenting an end outgoing from the converting unit UCONV and through which entry data that will be described further may be received from units or devices external to the converting unit UCONV.

By output physical interface, it is meant at least one physical interconnection, such as a pin or a plurality of pins, presenting an end outgoing from the converting unit UCONV through which data may be sent out to units or devices external to the converting unit UCONV.

The computing unit UCOMP receives, via the computing input physical interface INCOMP, a first image I₁, i.e. component values Rₚ₁, Gₚ₁, Bₚ₁ representing the first image I₁.

The computing unit UCOMP comprises a first image preparation module MPREP1 configured to produce (for each pixel p) a first luminance value L_{sdr1} based on the component values Rₚ₁, Gₚ₁, Bₚ₁ (of the concerned pixel p).

The first image preparation module MPREP1 may implement several steps for producing the first luminance value L_{sdr1} based on the component values Rₚ₁, Gₚ₁, Bₚ₁, for instance in the present case:
application of an inverse Opto-Electrical Transfer Function (or OETF⁻¹);
conversion from ITU-R BT.709 standard representation to ITU-R BT.2020 standard representation;
luminance computation from the ITU-R BT.2020 standard representation.

Thanks to the step of application of the inverse Opto-Electrical Transfer Function, the first luminance value L_{sdr1} produced by the first image preparation module MPREP1 represents a linear luminance component of the first image I₁.

The computing unit UCOMP further comprises a processing module MPROC.

The processing module MPROC is able to compute at least one parameter p₁ characteristic of the first image I₁. For instance, the processing module MPROC computes the at least one parameter p₁ characteristic of the first image I₁ based on the first luminance value L_{sdr} (for each pixel p). The at least one parameter characteristic of the first image I₁ may be a measure of the central tendency of the first luminance values L_{sdr1} of all pixels. All the values of the first luminance component L_{sdr1} can be considered for computing the at least one parameter characteristic of the first image I₁. For example, the measure of central tendency can be a median or a mean. In another example the at least one parameter p₁ characteristic of the first image I₁ is the maximum of all the first luminance values L_{sdr1}.

Once the computing unit UCOMP receives the first image I₁, i.e. the components values Rₚ₁, Gₚ₁, Bₚ₁ representing the first image I₁, the first image preparation module MPREP1 produces (for each pixel p) a first luminance value L_{sdr1}. Then, the processing module MPROC computes the at least one parameter characteristic of the first image I₁.

Once the processing module MPROC has computed the at least one parameter p₁ characteristic of the first image I₁, the computing unit UCOMP sends out the at least one parameter p₁ characteristic of the first image I₁ via the computing output physical interface OUTCOMP. The computing unit UCOMP is then ready, if case may be, for instance when the first image I₁ belongs to a sequence of images, to receive another image via the computing input physical interface INCOMP.

An example of implementation of the computing unit UCOMP with the FPGA technology is illustrated in FIG. 2.

In this example, optional configuring means are not included, and the FPGA allows converting an SDR image into an HDR image.

The computing input physical interface INCOMP receives RGB encapsulated input components R_{sdr}_{_{T1}}, G_{sdr}_{_{T}}₁, B_{sdr}_{_{T1}}, representing a first image I₁, encapsulated into a transport stream, each color component being expressed over 10 bits. The computing input physical interface INCOMP then transmits the RGB encapsulated input components R_{sdr}_{_{T1}}, G_{sdr}_{_{T}}₁, B_{sdr}_{_{T1}} to first conversion means MCV11 for converting them into the linear color components Rₚ₁, Gₚ₁, Bₚ₁. The conversion into linear color components involves look-up-tables LUT and a matrix multiplication by multiplication means MUL11 which provide the linear components expressed over 16 bits, on which further operations can be performed.

The first image preparation module MPREP1 is designed for calculating pixel per pixel, a weighted sum using the linear components provided by the first conversion means MCV11. The weighted sum corresponds to the linear luminance value L_{sdr1} associated to each pixel.

Optionally, first computing means MCOMP1 are present to pre-process the linear luminance value L_{sdr1} associated to each pixel. In this case, the first computing means MCOMP1 are realized using a 1DLUT.

The processing module MPROC is realized using a median filter.

The median value computed by the processing module MPROC corresponds to the at least one parameter p₁ characteristic of the first image I₁, which is transmitted out of the computing unit UCOMP.

The converting unit UCONV receives, via the converting input physical interface INCONV, a second image I₂, i.e. component values Rₚ₂, Gₚ₂, Bₚ₂ representing the second image I₂.

The converting unit UCONV also receives, via the parameter input physical interface INPAR, entry data that will be used for the luminance transformation.

The converting unit UCOMP comprises a second image preparation module MPREP2 configured to produce (for each pixel p) a second luminance value L_{sdr2} based on the component values Rₚ₂, Gₚ₂, Bₚ₂ (of the concerned pixel p).

The second image preparation module MPREP2 may implement several steps for producing the second luminance value L_{sdr2} based on the component values Rₚ₂, Gₚ₂, Bₚ₂, for instance in the present case:
application of an inverse Opto-Electrical Transfer Function (or OETF⁻¹);
conversion from ITU-R BT.709 standard representation to ITU-R BT.2020 standard representation;
luminance computation from the ITU-R BT.2020 standard representation.

Thanks to the step of application of the inverse Opto-Electrical Transfer Function, the second luminance value L_{sdr2} produced by the second image preparation module MPREP2 represents a linear luminance component of the second image I₂.

The converting unit UCONV comprises a mapping module MMAP. The mapping module MMAP is designed (as further explained below) to transform the second luminance value L_{sdr2} associated with any pixel p of the second image I₂ into an output luminance value L_{inter_hdr} associated with the corresponding pixel p′ of an intermediate image I_{inter_hdr}. The intermediate image I_{inter_hdr} corresponds to at least part of the output image I_{hdr}. The mapping module MMAP transforms the second luminance value L_{sdr2} associated with any pixel p of the second image I₂, based on the entry data.

An example of implementation of the converting unit UCONV with the FPGA technology is illustrated on FIG. 3.

In this example, optional configuring means are not included, and the FPGA allows converting SDR image into an HDR image.

The converting input physical interface INCONV receives RGB encapsulated input components R_{sdr}_{_{T}}₂, G_{sdr}_{_{T2}}, B_{sdr}_{_{T}}₂, encapsulated into a transport stream, each color component being expressed over 10 bits. The converting input physical interface INCONV then transmits the RGB encapsulated input components R_{sdr}_{_{T}}₂, G_{sdr}_{_{T2}}, B_{sdr}_{_{T2}} to first conversion means MCV12 for converting the RGB encapsulated input components R_{sdr}_{_{T}}₂, G_{sdr}_{_{T2}}, B_{sdr}_{_{T2}} into the linear color components Rₚ₂, Gₚ₂, Bₚ₂. The conversion into linear color components involves look-up-tables LUT and a matrix multiplication by multiplication means MUL12 which provide the linear components expressed over 16 bits, on which further operations can be performed.

The second image preparation module MPREP2 is designed for calculating pixel per pixel, a weighted sum using the linear components provided by the first conversion means MCV1. The weighted sum corresponds to the linear luminance value L_{sdr2} associated to each pixel.

The mapping module MMAP is able to receive, via the parameter input physical interface PARCONV, the at least one parameter p₁ characteristic of a first image I₁ received by the computing unit UCOMP.

The mapping module MMAP is able to receive the linear luminance value L_{sdr2}, element per element.

The mapping module MMAP comprises here:
a 2D look-up table (2DLUT) for indexing the linear luminance value L_{sdr2} element values, the values of parameters p₁ characteristic of a first image I₁ received by the computing unit UCOMP and corresponding pre-determined output luminance values memorized by using internal or external storing unit (not illustrated), and
an interpolation unit able to interpolate the element values of the output luminance component when necessary.

Finally, the conversion unit UCOMP also comprises correcting means MCOR able to provide the output image components (here R_{hdr}, G_{hdr} and B_{hdr}) from the output of the mapping module MMAP. In an alternative, the correcting means MCOR may be external to the processor.

The means MCOR comprising three look-up tables able to receive the linear components from the conversion means MCV12 to compute the linear output color components R_{hdr}, G_{hdr}, Bₕₐᵣ. The correction means MCOR allows to perform the additional saturation correction by using three LUT connected to three multipliers MUL able to receive the output luminance component values from the mapping module MMAP respectively.

The converting unit UCONV comprises second conversion means MCV2 for converting back the linear color components R_{hdr}, G_{hdr}, B_{hdr} into RGB encapsulated input components R_{hdr}_{_{T}}, G_{hdr}_{_{T}}, B_{hdr}_{_{T}} compatible with transportation through communication means. As for the first conversion means MCV12, the conversion made by the second conversion means MCV2 involves look-up-tables LUT and a matrix multiplication by multiplication means MUL2.

In a variant, the second image preparation module MPREP2 and the first image preparation module MPREP1 are one unique preparation module MPREP outside from the computing unit UCOMP and from the converting unit UCONV, configured to produce (for each pixel p) the first luminance value L_{sdr1} and the second luminance value L_{sdr2} based on the component values Rₚ₁, Gₚ₁, Bₚ₁ (of the concerned pixel p) and on the component values Rₚ₂, Gₚ₂, Bₚ₂ (of the concerned pixel p).

In a first embodiment, illustrated in FIG. 4 and referred to as high precision mode embodiment, the electronic device DEV1 comprises a computing unit UCOMP as previously described and illustrated on FIG. 1, a converting unit UCONV as previously described and illustrated on FIG. 1, and a buffer BUFF. The buffer BUFF is a physical memory storage. The buffer BUFF comprises a buffer input physical interface INBUFF and a buffer output physical interface OUTBUFF.

By buffer input physical interface, it is meant at least one physical interconnection, such as a pin or a plurality of pins, presenting an end outgoing from the buffer BUFF and through which data may be received from units or devices external to the buffer BUFF.

By buffer output physical interface, it is meant at least one physical interconnection, such as a pin or a plurality of pins, presenting an end outgoing from the buffer BUFF through which data may be sent out to units or devices external to the buffer BUFF.

In this first embodiment, the buffer BUFF receives, via the buffer input physical interface INBUFF, the first image I₁, i.e. the component values Rₚ₁, Gₚ₁, Bₚ₁ representing the first image I₁.

Once received, the buffer BUFF stores the component values Rₚ₁, Gₚ₁, Bₚ₁ representing the first image I₁ while the processing module MPROC computes the at least one parameter characteristic of the first image I₁.

Once the processing module MPROC has computed the at least one parameter p₁ characteristic of the first image I₁, the buffer BUFF transmits via the buffer output physical interface OUTBUFF the component values Rₚ₁, Gₚ₁, Bₚ₁ representing the first image I₁ to the converting unit UCONV. The converting unit UCONV receives the component values Rₚ₁, Gₚ₁, Bₚ₁ representing the first image I₁ via the converting input physical interface INCONV. The buffer BUFF and the converting unit UCONV are thus directly connected.

In an example of the high precision embodiment, the first image I₁ and the second image I₂ correspond to the input image I_{sdr}.

Thus, in this example, the computing unit UCOMP and the converting unit UCONV are directly connected. More specifically, the computing output physical interface OUTCOMP is connected to the parameter input physical interface INPAR. As a consequence, the at least one parameter p₁ characteristic of the first image I₁ is received by the converting unit UCONV via the parameter input interface INPAR. The at least one parameter p₁ characteristic of the first image I₁ is comprised in the entry data.

In a second embodiment illustrated in FIG. 5 and referred to as low latency embodiment, the electronic device DEV1 comprises a computing unit UCOMP and a converting unit UCONV as previously described and illustrated on FIG. 1. It is assumed that both the computing unit UCOMP and the converting unit UCONV receive successively the images composing the sequence of images. In this case, the first image I₁ and the second image I₂ correspond a current image, referred to as Iᵢ, of the sequence of images.

The case where the image Iᵢ is the initial image I₀ of the sequence of images is treated separately. In this case, the parameter input interface INPAR receives as entry data a default parameter, which is used to process the initial image I₀.

Once the converting unit UCONV has received the entry data, i.e. said default parameter, the mapping module MMAP transforms the second luminance value L_{sdr2} associated with any pixel p of the second image I₂ into the output luminance value L_{inter_hdr} associated with the corresponding pixel p′ of an intermediate image I_{inter_hdr}.

In case the current image Iᵢ is different from the initial image I₀ of the sequence of images, the computing unit UCOMP and the converting unit UCONV work in parallel on the current image Iᵢ.

When the computing unit UCOMP receives the first image I₁, i.e. the component values Rₚ₁, Gₚ₁, Bₚ₁ representing the first image I₁, the at least one parameter, referred to as pᵢ₋₁, characteristic of the image Iᵢ₋₁ preceding the first image Iᵢ has previously been sent out by the computing unit UCOMP.

When the converting unit UCONV receives the second image I₂, that is, the current image Iᵢ, the mapping module MMAP transforms the second luminance value L_{sdr2} associated with any pixel p of the second image I₂ into the output luminance value L_{inter_hdr} associated with the corresponding pixel p′ of an intermediate image I_{inter_hdr}. The mapping module MMAP transforms the second luminance value L_{sdr2} based on the at least one parameter pᵢ₋₁.

Therefore, in the low latency embodiment, time is saved thanks to the parallel working of the computing unit UCOMP and the converting unit UCONV on the same image.

In an example of the low latency embodiment, the current image Iᵢ corresponds to the input image I_{sdr}.

Thus, in this example, the computing unit UCOMP and the converting unit UCONV are directly connected. More specifically, the computing output physical interface is connected to the parameter input physical interface INPAR. As a consequence, the at least one parameter p₁ characteristic of the first image I₁ is received by the converting unit UCONV via the parameter input interface INPAR. The at least one parameter p₁ characteristic of the first image I₁ is comprised in the entry data.

In a third embodiment illustrated on FIG. 6 and referred to as upscaling embodiment, the electronic device DEV1 comprises a computing unit UCOMP as previously described and illustrated on FIG. 1, a converting unit UCONV as previously described and illustrated on FIG. 1 and an upscaling unit UUPSCAL able to upscale, that is, upsample, images. In this third embodiment, the first image Iᵢ is a low resolution image. The upscaling unit UPSCAL comprises an upscaling input physical interface INUPSC and an upscaling output physical interface OUTUPSC.

By upscaling input physical interface, it is meant at least one physical interconnection, such as a pin or a plurality of pins, presenting an end outgoing from the upscaling unit UUPSCAL and through which data may be received from units or devices external to the upscaling unit UUPSCAL.

By upscaling output physical interface, it is meant at least one physical interconnection, such as a pin or a plurality of pins, presenting an end outgoing from the upscaling unit UUPSCAL through which data may be sent out to units or devices external to the upscaling unit UUPSCAL.

The upscaling unit UUPSCAL receives the first image I₁ via the upscaling input physical interface INUPSC. The upscaling unit upscales the low resolution image into an image, referred to as high resolution image, presenting a higher resolution than the resolution of the low resolution image.

After having upscaled the low resolution image, the upscaling unit UUPSCAL transmits the high resolution image to the converting unit UCONV via the upscaling output physical interface OUTUPSC. In other words, the second image I₂ is the high resolution image.

This presents the advantage of limiting the computations performed by the computing unit UCOMP, or, more specifically, by the processing module MPROC. Besides, upscaling solutions are generally created and optimized for standard dynamic range. Thus, upscaling the first image I₁, that is, an image presenting a standard dynamic range, is advantageous in comparison to upscaling an image presenting a high dynamic range.

Another aspect of the invention pertains to an electronic system SYS1. This electronic system SYS1 allows advantageously for parallelizing processing.

In an embodiment illustrated in FIG. 7 and referred to as high precision weighting embodiment, the electronic system SYS1 comprises a plurality of N instances of the electronic device DEV1 according to the high precision embodiment, N being an integer higher or equal to 2.

In the high precision weighting embodiment, the N instances of the electronic device DEV1 comprise each a high precision memory MEMₕₚₖ. The high precision memory MEMₕₚ is a physical memory storage. The high precision memory MEMₕₚₖ comprises a high precision memory input physical interface INMEMₕₚₖ and a high precision memory output physical interface OUTMEMₕₚₖ.

In each of the N instances of the electronic device DEV1, the high precision memory MEMₕₚₖ is directly connected to the computing unit UCOMPₖ. More specifically, the computing output physical interface OUTCOMP is connected to the high resolution memory input physical interface INMEMₕₚₖ.

Therefore, once the processing module MPROCₖ has computed the at least one parameter p₁ characteristic of the first image I₁, the high precision memory MEMₕₚₖ receives the at least one parameter p₁ₖ characteristic of the first image I₁ from the computing unit UCOMPₖ.

The electronic system SYS1 comprises a first weighting unit UWEIGHT1. The first weighting unit UWEIGHT1 comprises a first weighting input physical interface INWEIGHT1 and a first weighting output physical interface OUTWEIGHT1.

Each of the N computing units UCOMP of the electronic system SYS1 receives a sub-image of the input image I_{sdr}. In other words, each first image received by each computing unit is a sub-image of the input image I_{sdr}. The N sub-images form a partition of the input image I_{sdr}.

The N high precision memory output physical interfaces OUTMEMₕₚₖ of the N high resolution memories are directly connected to the first weighting input interface INWEIGHT1. The first weighting unit UWEIGHT1 is thus able to receive, from the N high resolution memories, the N at least one parameter characteristic of the N first images received respectively by the N computing units UCOMP.

The first weighting unit UWEIGHT1 is able to compute a weighted average of the N at least one parameter characteristic of the N first images. In a particular embodiment, the first weighting unit UWEIGHT1 computes the average of the N at least one parameter characteristic of the N first images.

In this embodiment, the N second images correspond to the N sub-images and are stored respectively in the N buffers BUFFₖ while the N processing modules MPROCₖ compute the N at least one parameter characteristic of the N first images. Once the N processing modules MPROCₖ have computed the N at least one parameter characteristic of the N first images, the N buffers BUFFₖ transmit each of the N sub-images to each of the N converting units UCONVₖ.

The first weighting output physical interface OUTWEIGHT1 is directly connected to each of the N parameter input physical interfaces of the N converting units UCONVₖ.

After computation of the weighted average M₁ of the N at least one parameter characteristic of the N sub-images, the first weighting unit UWEIGHT1 transmits the weighted average M₁ to each of the N converting units UCONVₖ.

This case is interesting for instance when processing a 4K video, split into 4 sub-images.

In an embodiment, the first weighting unit UWEIGHT1 may be deactivated. In this case, the N converting units UCONVₖ receive the outputs of their corresponding UCOMPₖ. The N instances of the electronic device DEV1 work independently. This case is interesting for instance when processing four independent HD (high definition) videos in parallel.

In another embodiment illustrated on FIG. 8 and referred to as low latency weighting in low latency embodiment, the electronic system SYS1 comprises a plurality of N instances of the electronic device DEV1 according to the low latency embodiment, N being an integer higher or equal to 2.

In this low latency weighting embodiment, each of the N instances of the electronic device DEV1 comprises a low latency memory MEM_{IIk}. The low latency memory MEM_{IIk} is a physical memory storage. The low latency memory MEM_{IIk} comprises a low latency memory input physical interface INMEM_{IIk} and a low latency memory output physical interface OUTMEM_{IIk}.

In an instance of the electronic device DEV1, the low latency memory MEM_{IIk} is directly connected to the computing unit UCOMPk. More specifically, the computing output physical interface OUTCOMP is connected to the low latency memory input physical interface INMEM_{IIk}.

Therefore, in an instance of the electronic device DEV1, once the processing module MPROC has computed the at least one parameter p₁ characteristic of the first image I₁, the low latency memory MEM_{IIk} receives the at least one parameter p₁ characteristic of the first image I₁ from the computing unit UCOMPk.

In this low latency weighting embodiment, the electronic system SYS1 comprises a second weighting unit UWEIGHT2. The second weighting unit UWEIGHT2 comprises a second weighting input physical interface INWEIGHT2 and a second weighting output physical interface OUTAVER2.

The N low latency memory output physical interfaces OUTMEM_{IIk} of the N low latency memories of the N instances of the electronic device DEV1 are directly connected to the weighting input interface INAVER. The second weighting unit UWEIGHT2 is thus able to receive, from the N low latency memories, the N at least one parameter characteristic of the N first images received respectively by the N computing units UCOMP. The N first images are N sub-images of a current image Iᵢ of a sequence of images, forming a partition of the current image Iᵢ. The current image Iᵢ corresponds to the input image I_{sdr}.

The second weighting unit UWEIGHT2 is able to compute the weighted average Mᵢ of the N at least one parameter characteristic of the N first images and to send out the weighted average Mᵢ via the second weighting output interface OUTWEIGHT2.

The case where the current image Iᵢ is the initial image I₀ of the sequence of images is treated separately. In this case, only once the N computing units UCOMPₖ of the N instances of the electronic device DEV1 have sent out respectively each of the N the at least one parameter, referred to as p₀ₖ, characteristic of N sub-images via the N computing output physical interfaces OUTCOMP, the N converting units UCONV receive the N entry data via the N parameter input physical interfaces INPAR.

In case the image Iᵢ is different from the initial image I₀ of the sequence of images, each of the N first images received respectively by the N computing units UCOMP correspond to each of the N second images received respectively by the N converting units UCONVₖ. The N first images, or equivalently the N second images, form a partition of the current image Iᵢ.

The N computing units UCOMPₖ and the N converting units UCONVₖ work in parallel.

When the N computing units UCOMPₖ receive each of the N sub-images, i.e. component values Rₚₖ, Gₚₖ, Bₚₖ representing the N sub-images, the weighted average Mᵢ₋₁ of the N at least one parameter, referred to as p_{i-1,k}, characteristic of N sub-images forming a partition of the image Iᵢ₋₁ preceding the current image Iᵢ has previously been computed by the second weighting unit UWEIGHT2 and sent out via the second weighting output physical interface OUTWEIGHT2.

The weighted average Mᵢ₋₁ is received by each of the N converting units UCONVₖ.

Thus, when the N converting units UCONVₖ receive the N second images, each of the N mapping modules MMAPₖ transforms the second luminance value L_{sdr2} associated with any pixel p of each of the N second image I₂ into the output luminance value L_{inter_hdr,k} associated with the corresponding pixel p′ of the N intermediate images I_{inter_hdr,k}. The N mapping module MMAP transform the second luminance value based on the weighted average Mᵢ₋₁.

Meanwhile, the N processing modules MPROCₖ compute the N at least one parameter characteristic of each of the N first images.

The invention also relates to a method for converting an input image I_{sdr} having a first dynamic range Δsdr (for instance a standard dynamic range or SDR) into an output image I_{hdr} having a second dynamic range Δhdr distinct from the first dynamic (for instance a high dynamic range or HDR).

The method is implemented with an electronic device DEV1 or an electronic system SYS1 according to the invention.

In an embodiment, the method is implemented by an electronic device DEV1 according to the high precision embodiment.

A first image I₁ is received by the computing unit UCOMP and by the buffer BUFF via respectively the computing input physical interface INCOMP and the buffer input physical interface INBUFF. As described previously, the first image I₁ is for example represented by the component values Rₚ₁, Gₚ₁, Bₚ₁. The first image I₁ is the input image I_{sdr}.

The first image preparation module MPREP1 determines the first luminance values, respectively associated with each pixel p of the first image I₁, based on the components Rₚ₁, Gₚ₁, Bₚ₁.

The processing module MPROC computes then at least one parameter, referred to as p₁, characteristic of the first image I₁, while the buffer BUFF holds the first image I₁.

Once the processing module MPROC has computed the at least one parameter p₁ characteristic of the first image I₁, the buffer BUFF transmits the component values Rₚ₁, Gₚ₁, Bₚ₁ representing the first image I₁ to the converting unit UCONV. The converting unit UCONV receives the component values Rₚ₁, Gₚ₁, Bₚ₁ representing the first image I₁.

The second image preparation module MPREP2 determines the second luminance values, respectively associated with each pixel p of the first image I₁, based on the component Rₚ₁, Gₚ₁, Bₚ₁.

The converting unit UCONV receives the at least one parameter p₁ characteristic of the first image I₁ via the parameter input physical interface INPAR.

The mapping module MMAP transforms, based on the at least one parameter p₁ characteristic of the first image I₁, the second luminance value L_{sdr2} associated with any pixel p of the second image I_{sdr2} into an output luminance value L_{hdr} associated with the corresponding pixel p′ of the output image I_{hdr}.

In an embodiment, the method is implemented by an electronic device DEV1 according to the low latency embodiment. In this embodiment, the input image I_{sdr} is a current image Iᵢ of a sequence of images.

Both the computing unit UCOMP and the converting unit UCONV receive the current image Iᵢ.

The first image preparation module MPREP1 and the second image preparation module MPREP2 determine the current luminance values, respectively associated with each pixel p of the current image Iᵢ, based on the component Rₚᵢ, Gₚᵢ, Bₚᵢ.

The processing module MPROC computes then at least one parameter, referred to as pᵢ, characteristic of the current image Iᵢ. The computing unit UCOMP then sends out the at least one parameter pᵢ.

If the image Iᵢ is the initial image I₀ of the sequence of images, the computing unit UCOMP sends out the at least one parameter, referred to as p₀, characteristic of the initial image I₀ so that the converting unit UCONV receives it.

Once the converting unit UCONV has received the at least one parameter p₀, the mapping module MMAP transforms, based on the at least one parameter p₀, the current luminance value L_{sdr} associated with any pixel p of the initial image I₀, into the output luminance value L_{hdr} associated with the corresponding pixel p′ of the output image I_{hdr}.

In case the current image Iᵢ is different from the initial image I₀ of the sequence of images, the computing unit UCOMP and the converting unit UCONV work in parallel on the current image Iᵢ.

While the processing module MPROC computes the at least one parameter pᵢ characteristic of the current image Iᵢ, the mapping module MMAP transforms, by using the at least one parameter, referred to as pᵢ₋₁, characteristic of the image Iᵢ₋₁ preceding the current image Iᵢ and previously sent out by the computing unit UCOMP. The mapping module MMAP transforms the second luminance value L_{sdr2} associated with any pixel p of the second image I₂ into an output luminance value L_{hdr} associated with the corresponding pixel p′ of the output image I_{hdr}. The at least one parameter pᵢ will be available to be used by the converting unit UCONV when the converting unit UCONV receives the image Iᵢ₊₁ subsequent to the current image Iᵢ.

In another embodiment, the method is implemented by an electronic device DEV1 according to the upscaling embodiment. In this embodiment, the input image I_{sdr} is a low resolution image.

In this case, the low resolution image is received by the computing unit UCOMP and the upscaling unit UUPSCAL.

The first image preparation module MPREP1 determines the first luminance values, respectively associated with each pixel p of the low resolution image, based on the component Rₚₗᵣ, Gₚₗᵣ, Bₚₗᵣ representing the low resolution image.

The processing module MPROC computes then at least one parameter, referred to as pₗᵣ, characteristic of the low resolution image. Once the at least one parameter pₗᵣ has been computed, the computing unit UCOMP sends it out to the converting unit UCONV.

Meanwhile, the upscaling unit UUPSCAL upscales the low resolution image into an image having a higher resolution, referred to as high resolution image. Once the upscaling is performed, the upscaling unit UUPSCAL transmits the component values Rₚ₁, Gₚ₁, Bₚ₁ representing the first image I₁ to the converting unit UCONV. The converting unit UCONV receives the component values Rₚₕᵣ, Gₚₕᵣ, Bₚₕᵣ representing the high resolution image.

The second image preparation module MPREP2 determines the second luminance values, respectively associated with each pixel p of the high resolution image, based on the component Rₚₕᵣ, Gₚₕᵣ, Bₚₕᵣ.

The mapping module MMAP transforms the second luminance value L_{sdr2} associated with any pixel p of the high resolution image into an output luminance value L_{hdr} associated with the corresponding pixel p′ of the output image I_{hdr}.

In an embodiment, the method is implemented with the electronic system SYS1 according to the weighting in high resolution mode embodiment.

In this embodiment, the N computing units UCOMP and the N buffers BUFFₖ receive each a sub-image I_{subk} of the input image I_{sdr}. The N sub-images I_{subk} form a partition of the input image I_{sdr}. For instance, if the input image I_{sdr} is a 4K image, it can be divided into 4 sub-images in high definition HD.

The N first image preparation modules MPREP₁ₖ determine the first luminance values, respectively associated with each pixel p of each sub-image I_{subk}, based on the component Rₚₖ, Gₚₖ, Bₚₖ.

Then the N processing modules MPROCₖ compute the N at least one parameter characteristic of the sub-images I_{subk}. Meanwhile, each of the N buffers BUFF stores the corresponding sub-image I_{subk}.

Once the N at least one parameter characteristic of the sub-images I_{subk} are computed, they are sent by each of the N computing units UCOMPₖ to each of the N high resolution memories where they are stored.

Meanwhile, each of the N buffers BUFFₖ transmits the component values Rₚₖ, Gₚₖ, Bₚₖ representing the N sub-images I_{subk} to the N converting units UCONVₖ. The N second image preparation modules MPREP₂ₖ then determine the second luminance values, respectively associated with each pixel p of the N sub-images I_{subk}, based on the component Rₚₖ, Gₚₖ, Bₚₖ.

The N at least one parameter characteristic of each sub-image I_{subk} are then sent to the first weighting unit UWEIGHT1. The first weighting unit UWEIGHT1 then computes the weighted average M1 of the N at least one parameter characteristic of the N sub-images I_{subk}. The weighted average M1 is then sent to each of the N converting units UCONVₖ.

Each of the N mapping modules MMAP transforms the second luminance values L_{sdr2} associated with any pixel p of each of the N sub-image I_{subk} into output luminance values L_{hdr} associated with the corresponding pixel p′ of N sub-images Sₒᵤₜₖ of the output image I_{hdr}. The N sub-images Sₒᵤₜₖ are then assembled to form the output image I_{hdr}.

This embodiment presents the advantage that a unique value for the parameter characteristic of each of the sub-images is used, resulting in minimized visual artefacts. In an embodiment, the method is implemented with the electronic system SYS1 according to the weighting in low latency mode embodiment. The input image I_{sdr} is a current image Iᵢ of a sequence of images.

The N first images are N sub-images I_{subk} of a current image Iᵢ of a sequence of images, forming a partition of the current image Iᵢ.

The N computing units UCOMP receive each a sub-image I_{subk}. The N converting units UCONVₖ also receive the N sub-images I_{subk}.

The N first image preparation modules MPREP₁ₖ determine the first luminance values, respectively associated with each pixel p of each sub-image I_{subk}, based on the component Rₚₖ, Gₚₖ, Bₚₖ representing the sub-images I_{subk}.

The N second image preparation modules MPREP2k determine the second luminance values, respectively associated with each pixel p of each sub-image I_{subk}, based on the component Rₚₖ, Gₚₖ, Bₚₖ representing the sub-images I_{subk}.

In the case where the current image Iᵢ is the initial image I₀ of the sequence of images, the N processing modules MPROCₖ compute the N at least one parameter characteristic of the sub-images I_{subk}. The N computing units UCOMP of the N instances of the electronic device DEV1 then send out respectively each of the N at least one parameter, referred to as p₀ₖ, characteristic of the N sub-images to each of the N low latency memories for storage.

Then, the second weighting unit UWEIGHT2 receives the N at least one parameter p₀ₖ and computes a weighted average M₂₀ of them.

The N mapping modules MMAPₖ transform, based on the weighted average M_{2,0}, the second luminance value L_{sdr2} associated with any pixel p of the sub-image I_{subk} into an output luminance value L_{hdr} associated with the corresponding pixel p′ of a sub-image Sₒᵤₜₖ of the output image I_{hdr}. The N sub-images Sₒᵤₜₖ are then assembled to form the output image I_{hdr}.

In the case where the current image Iᵢ is different from the initial image I₀ of the sequence of images, when the N computing units UCOMPₖ receive the N sub-images I_{subk}, i.e. component values Rₚₖ, Gₚₖ, Bₚₖ representing the N sub-images I_{subk}, the weighted average M_{2,i-1} of the N at least one parameter, referred to as p_{i-1,k}, characteristic of N sub-images of the image Iᵢ₋₁ preceding the current image Iᵢ has previously been computed by the second weighting unit UWEIGHT2 and sent out.

The weighted average M_{2,i-1} is received by each of the N converting units UCONVₖ.

While the N processing modules MPROC compute the N at least one parameter characteristic of each of the sub-image I_{subki} in view of the weighted average computation by the second weighting unit UWEIGHT2, the N mapping modules MMAPₖ transform, based on the weighted average M_{2,i-1}, the second luminance value L_{sdr2} associated with any pixel p of the N sub-images I_{subk} into output luminance values L_{hdr} associated with the corresponding pixel p′ of N sub-images Sₒᵤₜₖᵢ of the output image I_{hdr}. The N sub-images Sₒᵤₜₖᵢ are then assembled to form the output image I_{hdr}.

The advantage of this embodiment is to allow each instance of the computing units and of the converting units to work in parallel, thus increasing the transmission rate. In contrast, the high precision embodiments use the parameters computed from the same image, so that the underlying model is more accurately applied.

One other aspect of the invention pertains to a method for converting the luminance values of a first sequence of images and of a second sequence of images simultaneously, i.e. by multiplexing the two sequences of images.

In an embodiment, the method for converting the luminance values of a first sequence of images and of a second sequence of images simultaneously is implemented with an electronic device DEV1 according to high resolution embodiment. In this embodiment, the electronic device DEV1 additionally comprises a first parameter memory and a second parameter memory. The first parameter memory stores parameters pertaining to properties of the first sequence of images such as the frame resolution, frame rate, the input or output EOTF. The parameters pertaining to properties of the first sequence of images are received by both the computing unit UCOMP and the converting unit UCONV, via respectively the computing input physical interface INCOMP and the converting input physical interface INCONV. The second parameter memory stores the equivalent parameters for the second sequence of images. The parameters pertaining to properties of the second sequence of images are received by both the computing unit UCOMP and the converting unit UCONV, via respectively the computing input physical interface INCOMP and the converting input physical interface INCONV.

The following steps are carried out and repeated, as illustrated in FIG. 9. A frame I_{Ai} of the first sequence of images is processed by the computing unit UCOMP so as to produce the at least one parameter p_{Ai} characteristic of the frame I_{Ai} and while the buffer BUFF holds the frame I_{Ai} before sending it to the converting unit UCONV. Then the at least one parameter p_{Ai} is sent to the converting unit UCONV. While the converting unit UCONV processes the frame I_{Ai}, a frame I_{Bi} of the second sequence of images is processed by the computing unit UCOMP so as to produce the at least one parameter psi characteristic of the frame I_{Bi}. Then the at least one parameter p_{Bi} is sent to the converting unit UCONV, freeing the computing unit UCOMP which becomes available to process the frame I_{Ai+1} subsequent to the frame I_{Ai} in the same manner.

In another embodiment, the method for converting the luminance values of a first sequence of images and of a second sequence of images simultaneously is implemented with an electronic device DEV1 according to the low latency embodiment. In this other embodiment, the electronic device DEV1 additionally comprises a first parameter memory and a second parameter memory. The first parameter memory stores parameters pertaining to properties of the first sequence of images such as the frame resolution, frame rate, the input or output EOTF. The parameters pertaining to properties of the first sequence of images are received by both the computing unit UCOMP and the converting unit UCONV, via respectively the computing input physical interface INCOMP and the converting input physical interface INCONV. The second parameter memory stores the equivalent parameters for the second sequence of images. The parameters pertaining to properties of the second sequence of images are received by both the computing unit UCOMP and the converting unit UCONV, via respectively the computing input physical interface INCOMP and the converting input physical interface INCONV.

The following steps are carried out and repeated, as illustrated in FIG. 10. A current frame I_{Ai} of the first sequence of images is processed by the computing unit UCOMP so as to produce and make available the at least one parameter p_{Ai} characteristic of the frame I_{Ai}. The at least one parameter p_{Ai-1} is already available to be used by the converting unit UCONV. While the computing unit UCOMP processes the current frame I_{A1}, the converting unit UCONV processes the current frame I_{Ai} by using the at least one parameter p_{Ai-1}.

Then, once the computing unit UCOMP has processed the current frame I_{Ai} and produced the at least one parameter p_{Ai}, the computing unit UCOMP receives a current frame I_{Bi} of the second sequence of images and processes it to produce the at least one parameter psi characteristic of the current frame I_{Bi}. In parallel, the converting unit UCONV process the current frame I_{Bi} by using the available at least one parameter p_{Bi-1} characteristic of the frame I_{Bi-1} preceding the current frame I_{Bi}.

Once the computing unit UCOMP has produced the at least one parameter p_{Bi} characteristic of the current frame I_{Bi}, the computing unit UCOMP is available to process the frame I_{Ai+1} subsequent to the frame I_{Ai}.

Thus, the separation of the computing unit UCOMP and of the converting unit UCONV allows such a multiplexing process that is not possible to implement with monolithic architectures. This separation provides flexibility in the arrangement of the computing unit UCOMP and of the converting unit UCONV with for instance other independent components. Depending on this arrangement, either a high precision functioning can be obtained or a higher frame rate might be achieved. This separation also allows for parallel processing.

1. An electronic device for converting an input image having a first dynamic range into an output image having a second dynamic range different from the first dynamic range, the electronic device comprising:
circuitry comprising
a computing input physical interface, the circuitry being configured to receive data representative of a first image via the computing input physical interface, and
a computing output physical interface,
the circuitry being configured to compute at least one statistical parameter characteristic of the first image and transmit the at least one statistical parameter via the computing output physical interface; and
a converter comprising
a converting input physical interface, the converter being configured to receive data representative of a second image via the converting input physical interface,
a parameter input physical interface, the converter being configured to receive entry data via the parameter input physical interface, and
a converting output physical interface,
the converter being configured to convert the second image into at least one part of the output image based on the entry data.

2. The electronic device according to claim 1, further comprising a buffer comprising
a buffer input physical interface, the buffer being configured to receive the data representative of the first image via the buffer input physical interface and to store the data representative of the first image while the circuitry computes the at least one statistical parameter characteristic of the first image, and
a buffer output physical interface, the buffer being configured to transmit the data representative of the first image via the buffer output physical interface to the converter via the converting interface input physical once the circuitry has computed the at least one statistical parameter characteristic of the first image.

3. The electronic device according to claim 2, wherein the entry data comprise the at least one statistical parameter characteristic of the first image.

4. The electronic device according to claim 2, further comprising a memory comprising
a memory input physical interface, the memory being configured to receive the at least one statistical parameter characteristic of the first image from the first output physical interface via the memory input physical interface, and
a memory output physical interface,
wherein the first image corresponds to an image inferred from another image.

5. The electronic device according to claim 1, wherein:
the first image and the second image are two successive images of a sequence of images, and
the entry data are based on the at least one statistical parameter characteristic of the first image.

6. The electronic device according to claim 5, wherein the entry data comprise the at least one statistical parameter characteristic of the first image.

7. The electronic device according to claim 5, further comprising a memory comprising a memory input physical interface and a memory output physical interface, the memory being configured to receive, once the circuitry has computed the at least one statistical parameter characteristic of the first image, said at least one statistical parameter characteristic of the first image, and to transmit said at least one statistical parameter characteristic of the first image via the memory output physical interface, and
the second image corresponds to a second sub-image of the input image.

8. The electronic device according to claim 1, further comprising at least one parameter memory configured to store properties of the input image.

9. The electronic device according to claim 1, further comprising an upscaling system comprising an upscaling input physical interface and an upscaling output physical interface,
the first image corresponds to a low resolution image,
the upscaling system is configured to receive data representative of the low resolution image via the upscaling input physical interface, to upscale the low resolution image into a high resolution image and to transmit data representative of the high resolution image via the upscaling output physical interface to the converter via the converting input physical interface.

10. An electronic system comprising:
a plurality of electronic devices according to claim 4 including a first electronic device and a second electronic device; and
a weighting system including a weighting input physical interface and a weighting output physical interface,
wherein the memory of the first electronic device and the memory of the second electronic device are configured to transmit the at least one statistical parameter respectively characteristic of the first sub-image received by the circuitry of the first electronic device and the first sub-image received by the circuitry of the second electronic device to the weighting system via the memory output physical interface of the first electronic device and the memory output physical interface of the second electronic device,
the weighting system is configured to compute a weighted average of the at least one statistical parameter respectively characteristic of the first image received by the circuitry of the first electronic device and the first image received by the circuitry of the second electronic device, and
the entry data received by the first electronic device and the entry data received by the second electronic device comprise said weighted average.

11. An electronic system comprising:
a plurality of electronic devices according to claim 7 including a first electronic device and a second electronic device; and
a weighting system comprising a weighting input physical interface and a weighting output physical interface,
the memory of the first electronic device and the memory of the second electronic device are configured to transmit the at least one statistical parameter respectively characteristic of the first image received by the circuitry of the first electronic device and the first image received by the circuitry of the second electronic device to the weighting system via the memory output physical interface of the first electronic device and the memory output physical interface of the second electronic device,
the weighting system is configured to compute a weighted average of the at least one statistical parameter respectively characteristic of the first image received by the circuitry of the first electronic device and the first image received by the circuitry of the second electronic device,
the second image received by the converter of the first electronic device and the second image received by the converter of the second electronic device are sub-images of the input image, and
the entry data received by the first electronic device and the entry data received by the second electronic device comprise said weighted average.

12. A method for converting an input image having a first dynamic range into an output image having a second dynamic range different from the first dynamic range, the method comprising:
receiving, by a circuitry via a computing input physical interface of the circuitry, data representative of a first image;
computing, by the circuitry, at least one statistical parameter characteristic of the first image;
receiving, by a converter via a converting input physical interface of the converter, data representative of a second image;
receiving, by the converter via a parameter input physical interface of the converter, entry data; and
converting, by the converter, the second image into at least one part of the output image, based on the entry data.

13. The method according to claim 12, wherein:
the data representative of the first image are received by a buffer via a buffer input physical interface of the buffer and stored by the buffer while the circuitry computes the at least one statistical parameter characteristic of the first image, and
the data representative of the first image are received by the converter, via the converting input physical interface, from the buffer via a buffer output physical interface of the buffer once the circuitry has computed the at least one statistical parameter characteristic of the first image.

14. The method according to claim 13, wherein the entry data comprise the at least one statistical parameter characteristic of the first image.

15. The method according to claim 13, wherein:
the at least one statistical parameter characteristic of the first image is received from the circuitry via a computing output physical interface by a memory via a memory input physical interface, and
the first image corresponds to a first sub-image of the input image.

16. The method according to claim 12, wherein:
the first image and the second image are two successive images of a sequence of images, and
the entry data are based on the at least one statistical parameter characteristic of the first image.

17. The method according to claim 16, wherein the entry data comprise the at least one statistical parameter characteristic of the first image.

18. The method according to claim 16, wherein:
once the circuitry has computed the at least one statistical parameter characteristic of the first image that, the at least one statistical parameter characteristic of the first image is received by a memory via a memory input physical interface, then transmitted via the memory output physical interface, and
the second image corresponds to a second sub-image of the input image.

19. The method according to claim 12, wherein:
the first image corresponds to a low resolution image,
data representative of the low resolution image are received by an upscaling system via an upscaling input physical interface,
the low resolution image is upscaled by the upscaling system into a high resolution image, and
data representative of the high resolution image are transmitted by the upscaling system via an upscaling output physical interface to the converter via the converting input physical interface.

20. A method for converting an input image having a first dynamic range into an output image having a second dynamic range different from the first dynamic range, the method comprising:
receiving, by first circuitry and second circuitry via respectively a first computing input physical interface of the first circuitry and a second computing input physical interface of the second circuitry, first sub-images of the input image;
computing, respectively by the first circuitry and the second circuitry, at least one first statistical parameter at least one second statistical parameter;
receiving, by a first converter and a second converter respectively via a first converting input physical interface of the first converter and a second converting input physical interface of the second converter, second sub-images of the input image;
receiving, by a weighting system via a weighting input physical interface, the at least one first statistical parameter and the at least one second statistical parameter;
computing, by the first weighting system, a weighted average of the at least one first statistical parameter and the at least one second statistical parameter;
receiving and storing, by a first buffer and a second buffer respectively via a first buffer input physical interface of the first buffer and a second buffer input physical interface of the second buffer, data representative of the first sub-images, while the first circuitry and the second circuitry compute the at least one first statistical parameter and the at least one second statistical parameter;
transmitting, by the first buffer and the second buffer, said data representative of the first sub-images, respectively to the first converter and the second converter, once the first circuitry and the second circuitry have computed the at least one first statistical parameter and the at least one second statistical parameter;
receiving, by the first converter and the second converter respectively via a first parameter input physical interface and a second parameter input physical interface, entry data comprising the weighted average; and
converting, by the first converter and the second converter, the second sub-images into the output image, based on the entry data.

21. A method for converting an input image a first dynamic range into an output image having a second dynamic range different from the first dynamic range, the method comprising:
receiving, by first circuitry and second circuitry respectively via a first computing input physical interface of the first circuitry and a second computing input physical interface of the second circuitry, first sub-images of a preceding image, the preceding image and the input image being two successive images in a sequence of images;
computing, respectively by the first circuitry and the second circuitry, at least one first statistical parameter and at least one second statistical parameter;
receiving, by a first converter and a second converter respectively via a first converting input physical interface of the t first converter and a second converting input physical interface of the second converter, second sub-images of the input image;
receiving, by a first memory and a second memory via respectively a first memory input physical interface and a second memory input physical interface, once the first circuitry and the second circuitry have computed the at least one first statistical parameter and the least one second statistical parameter, said at least one first statistical parameter and said second at least one statistical parameter;
receiving, from the first memory and the second memory, by a weighting system via a weighting input physical interface, the at least one first statistical parameter and the second at least one second statistical parameter;
computing, by the weighting system, a weighted average of the at least one first statistical parameter and the at least one second statistical parameter;
receiving, by the first converter and the second converter respectively via a first parameter input physical interface and a second parameter input physical interface, entry data each comprising the weighted average; and
converting, by the first converter and the second converter, the second sub-images into the output image based on the entry data.

22. A method, implemented by the electronic device according to claim 1, for converting a first sequence of images and a second sequence of images, the method comprising:
applying a current image of the first sequence of images to the via the computing input physical interface, thereby producing at least one statistical parameter characteristic of said current image of the first sequence of images, while applying a current image of the second sequence of images to the converter via the converting input physical interface; and
applying the image subsequent to said current image of the second sequence of images to the circuitry via the computing input physical interface, while applying the current image of the first sequence of images and the at least one statistical parameter characteristic of said current image of the first sequence of images to the converter respectively via the converting input physical interface and the parameter input physical interface.

23. A method, implemented by the electronic device according to claim 1, for converting a first sequence of images and a second sequence of images, the method comprising:
applying a current image of the first sequence of images to the circuitry via the computing input physical interface, thereby producing the at least one statistical parameter characteristic of said current image of the first sequence of images, while applying a current image of the second sequence of images to the converter via the converting input physical interface; and
applying the image subsequent to said current image of the second sequence of images to the circuitry via the computing input physical interface, while applying the current image of the first sequence of images and the at least one statistical parameter characteristic of said current image of the first sequence of images to the via converter respectively via the converting input physical interface and the parameter input physical interface.
